(19) United States
(12) Patent Application Publication
(10) Pub. No.: US 2024/0272976 A1
(43) Pub. Date: Aug. 15, 2024

(54) ABNORMALITY DETECTION DEVICE, ABNORMALITY DETECTION METHOD, AND ABNORMALITY DETECTION PROGRAM

(71) Applicant: NIPPON TELEGRAPH AND TELEPHONE CORPORATION, Tokyo (JP)

(72) Inventors: Eri NAKAHARA, Musashino-shi, Tokyo (JP); Tetsuya SHIODA, Musashino-shi, Tokyo (JP); Machiko TOYODA, Musashino-shi, Tokyo (JP)

(73) Assignee: NIPPON TELEGRAPH AND TELEPHONE CORPORATION, Tokyo (JP)

(21) Appl. No.: 18/570,076

(22) PCT Filed: Jun. 21, 2021
(86) PCT No.: PCT/JP2021/023416

§ 371 Date: Dec. 14, 2023

(51) Int. Cl. G06F 11/07; G06F 18/213; G06F 123/02

(52) U.S. Cl. CPC G06F 11/0769; G06F 18/213; G06F 2123/02

(57) ABSTRACT

An abnormality detection apparatus includes an acquisition unit that acquires time-series data of a detection target whose abnormality is detected at a predetermined point in time, a first extraction unit that extracts a feature in a feature quantity direction in a time section before the predetermined point in time from the time-series data, a second extraction unit that extracts a feature in a time direction in the time section from the feature in the feature quantity direction, and a calculation unit that calculates an abnormality score at a predetermined point in time on the basis of the feature in the feature quantity direction and the feature in the time direction, and calculates the degree of contribution in the feature quantity direction and the degree of contribution in the time direction before the predetermined point in time with respect to the abnormality score.

### TECHNICAL FIELD

The present invention relates to an abnormality detection apparatus, an abnormality detection method, and an abnormality detection program.

### BACKGROUND ART

In abnormality detection using machine learning technology, a model through unsupervised learning is created by using normal data when abnormality occurs very infrequently. An abnormality score indicating a deviation from a normal state is calculated. A threshold value is set for the calculated abnormality score to perform a determination of abnormality or normality. For abnormality detection in machine learning, there are a scheme that can be applied regardless of time-series data by treating each sample independently, and a scheme for time-series data that sets a time window and considers an order of samples in a range thereof (hereinafter referred to as “time-series abnormality detection”).

Here, the time window set in time-series abnormality detection refers to a window that divides the time-series data into certain sections. When a model is created, a behavior is learned using data within the time window while shifting in a time direction. In the time-series abnormality detection, a behavior of the time-series data in normal time is learned, and an abnormality score is calculated using a prediction error, which is a difference between a predicted value and an actually measured value. Since a sample with a behavior similar to normal time-series data learned at the time of model training has a small prediction error, and am untrained sample has a large prediction error, it is possible to detect an abnormality from the time-series data using this characteristics.

As described above, in the abnormality detection using a machine learning technology, a determination is made that an abnormality has occurred depending on whether the abnormality score of the predicted sample exceeds a preset abnormality determination threshold value, and an abnormality occurrence time is identified. However, since the abnormality score only allows detection of a time when an abnormality has occurred, and a feature quantity serving as an abnormality occurrence cause is not known, additional analysis such as confirmation of a behavior before and after the sample exceeding the threshold value is required.

On the other hand, an example of an existing technology for identifying a feature quantity serving as the abnormality occurrence cause includes a technology for calculating a degree of contribution using a trained model or the like. Here, the degree of contribution indicates a degree of influence on a result output by a machine learning model, and a determination can be made that a higher degree of contribution indicates a cause of the abnormality. Further, there is also a technology for outputting a degree of contribution in consideration of the context of input data in a time direction and indicating which time of the input data contributed to a classification result (for example, see NPL 1).

### CITATION LIST

### Non Patent Literature

[NPL 1] R. Assaf, et al. “MTEX-CNN: Multivariate Time series EXplanations for Predictions with Convolutional Neural Networks”, 2019 IEEE International Conference on Data Mining (ICDM), pp. 952-957, [online], [retrieved on Jun. 8, 2021], Internet <https://ieeexplore.ieee.org/stamp/stamp.jsp?tp=&arnumber=8970899&tag=1>

### SUMMARY OF INVENTION

### Technical Problem

However, in the related art described above, in unsupervised abnormality detection, it is not possible to facilitate cause identification in consideration of time-series characteristics. This is because the related art described above has the following problems.

First, in the technology of outputting the degree of contribution using the trained model or the like, since each sample is handled independently in the time direction, the degree of contribution is output without considering the context of the data in the time direction. Further, since the technology for outputting the degree of contribution in consideration of the context of the input data in the time direction is a scheme for supervised learning and a classification problem, the technology cannot be directly applied to an abnormality detection technology without supervised data.

### Solution to Problem

In order to solve the above-described problems and achieve the object, an abnormality detection apparatus according to the present invention includes an acquisition unit configured to acquire time-series data of a detection target whose abnormality is detected at a predetermined point in time; a first extraction unit configured to extract a feature in a feature quantity direction in a time section before the predetermined point in time from the time-series data; a second extraction unit configured to extract a feature in a time direction in the time section from the feature in the feature quantity direction; and a calculation unit configured to calculate an abnormality score at a predetermined point in time on the basis of the feature in the feature quantity direction and the feature in the time direction, and calculate the degree of contribution in the feature quantity direction and the degree of contribution in the time direction before the predetermined point in time with respect to the abnormality score.

Further, an abnormality detection method according to the present invention is an abnormality detection method executed by an abnormality detection apparatus, the abnormality detection method including: an acquisition step of acquiring time-series data of a detection target whose abnormality is detected at a predetermined point in time; a first extraction step of extracting a feature in a feature quantity direction in a time section before the predetermined point in time from the time-series data; a second extraction step of extracting a feature in a time direction in the time section from the feature in the feature quantity direction; and a calculating step of calculating an abnormality score at a predetermined point in time on the basis of the feature in the feature quantity direction and the feature in the time direction, and calculating the degree of contribution in the feature quantity direction and the degree of contribution in the time direction before the predetermined point in time with respect to the abnormality score.

Further, an abnormality detection program according to the present invention causes a computer to execute: an acquisition step of acquiring time-series data of a detection target whose abnormality is detected at a predetermined point in time; a first extraction step of extracting a feature in a feature quantity direction in a time section before the predetermined point in time from the time-series data; a second extraction step of extracting a feature in a time direction in the time section from the feature in the feature quantity direction; and a calculating step of calculating an abnormality score at a predetermined point in time on the basis of the feature in the feature quantity direction and the feature in the time direction, and calculating the degree of contribution in the feature quantity direction and the degree of contribution in the time direction before the predetermined point in time with respect to the abnormality score.

### Advantageous Effects of Invention

In the present invention, in unsupervised abnormality detection, cause identification taking time-series characteristics into consideration is facilitated.

### BRIEF DESCRIPTION OF DRAWINGS

FIG. 1 is a diagram illustrating an example of an abnormality detection system according to a first embodiment.

FIG. 2 is a block diagram illustrating a configuration example of an abnormality detection apparatus according to the first embodiment.

FIG. 3 is a diagram illustrating an example of an architecture of a learning model according to the first embodiment.

FIG. 4 is a diagram illustrating an example of feature extraction processing according to the first embodiment.

FIG. 5 is a diagram illustrating an example of learning data according to the first embodiment.

FIG. 6 is a diagram illustrating an example of evaluation data according to the first embodiment.

FIG. 7 is a diagram illustrating an example of data processing according to the first embodiment.

FIG. 8 is a diagram illustrating an example of data processing according to the first embodiment.

FIG. 9 is a diagram illustrating an example of data processing according to the first embodiment.

FIG. 10 is a diagram illustrating an example of a flow of an abnormality detection accuracy evaluation processing according to the first embodiment.

FIG. 11 is a diagram illustrating an example of an abnormality detection accuracy evaluation processing according to the first embodiment.

FIG. 12 is a diagram illustrating an example of an abnormality detection accuracy evaluation processing according to the first embodiment.

FIG. 13 is a diagram illustrating an example of a flow of degree-of-contribution evaluation processing according to the first embodiment.

FIG. 14 is a diagram illustrating an example of processing for calculating a degree of contribution in a feature quantity direction according to the first embodiment.

FIG. 15 is a diagram illustrating an example of processing of calculating a degree of contribution in a time direction according to the first embodiment.

FIG. 16 is a diagram illustrating an example of degree-of-contribution evaluation processing according to the first embodiment.

FIG. 17 is a diagram illustrating an example of a result of evaluating effectiveness of the architecture of the learning model according to the first embodiment.

FIG. 18 is a diagram illustrating an example of a result of evaluating effectiveness of the architecture of the learning model according to the first embodiment.

FIG. 19 is a diagram illustrating an example of a result of evaluating effectiveness of an architecture of the learning model according to the first embodiment.

FIG. 20 is a diagram illustrating a result of evaluating effectiveness of an architecture of the learning model according to the first embodiment.

FIG. 21 is a diagram illustrating an example of a result of evaluating effectiveness of an architecture of the learning model according to the first embodiment.

FIG. 22 is a diagram illustrating an example of a result of evaluating effectiveness of an architecture of the learning model according to the first embodiment.

FIG. 23 is a diagram illustrating an example of a result of evaluating the effectiveness of the architecture of the learning model according to the first embodiment.

FIG. 24 is a diagram illustrating an example of a result of evaluating effectiveness of the architecture of the learning model according to the first embodiment.

FIG. 25 is a diagram illustrating an example of a result of evaluating effectiveness of an architecture of the learning model according to the first embodiment.

FIG. 26 is a flowchart illustrating an example of a flow of overall processing according to the first embodiment.

FIG. 27 is a diagram illustrating a computer that executes a program.

### DESCRIPTION OF EMBODIMENTS

Hereinafter, embodiments of an abnormality detection apparatus, an abnormality detection method, and an abnormality detection program according to the present invention will be described in detail on the basis of the drawings. The present invention is not limited by the embodiments to be described below.

### First Embodiment

The processing of an abnormality detection system according to a first embodiment (appropriately, the present embodiment), the comparison between the related art and the present embodiment, the configuration of the abnormality detection apparatus 10, details of processing, and a flow of the processing will be described below in order, and finally the effects of the present embodiment will be described.

### [Processing of Abnormality Detection System]

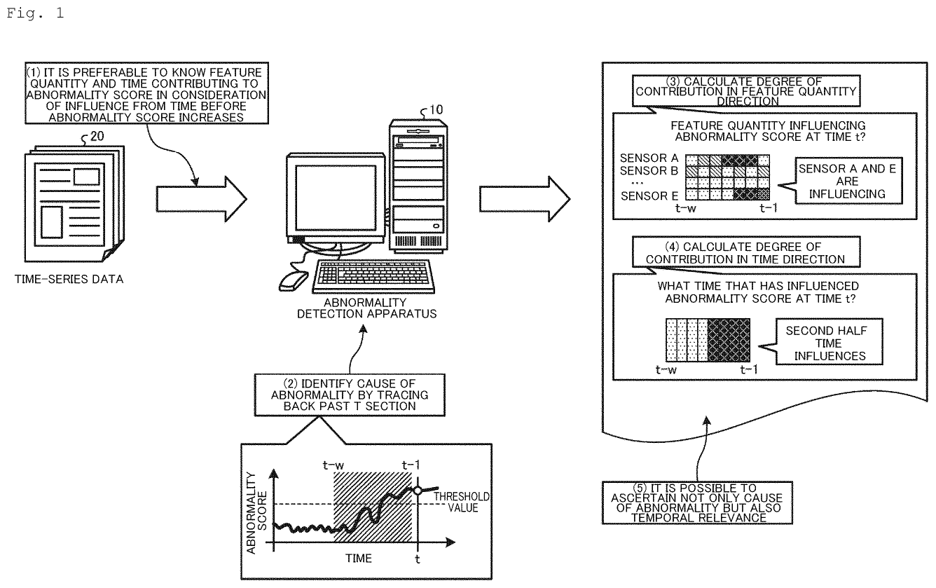

Processing of the abnormality detection system according to the present embodiment (appropriately, the present system) will be described with reference to FIG. 1. FIG. 1 is a diagram illustrating an example of the abnormality detection system according to the first embodiment. The present system includes an abnormality detection apparatus 10. The abnormality detection system illustrated in FIG. 1 may include a plurality of abnormality detection apparatuses 10.

Further, in the present system, time-series data 20 is involved as data acquired by the abnormality detection apparatus 10. Here, the time-series data 20 is data that considers an order of each sample and is data including time-series information.

In the system as described above, an example of Convolutional Neural Network (hereinafter referred to as “CNN”)-based abnormality detection processing in which a single time-series abnormality detection model can be used to calculate abnormality scores, and regardless of whether the abnormality scores are high or low, a degree of contribution for identifying a time and feature quantity appearing to be a cause of an abnormality can be calculated will be described.

First, the abnormality detection apparatus 10 acquires the time-series data 20. In this case, it is preferable to, through the processing of the abnormality detection apparatus 10, not only detect an abnormality from the abnormality score, but also consider an influence from a time before the abnormality score rises to find the feature quantity and time that contributed to the abnormality score (See FIG. 1(1)).

Next, the abnormality detection apparatus 10 identifies the cause of the abnormality by tracing back to a specific past time from an abnormality occurrence time (see FIG. 1(2)). In the example of FIG. 1, the cause of the abnormality at an abnormality occurrence time t is identified in a section from time t-w to t−1, while going back w hours from the abnormality occurrence time t.

The abnormality detection apparatus 10 calculates the degree of contribution in the feature quantity direction on the basis of the time-series data 20 (see FIG. 1(3)). In the example of FIG. 1, it can be seen from the calculated degree of contribution that the feature quantity that has influenced the abnormality score at time t is a feature quantity regarding a sensor A and a sensor E.

Further, the abnormality detection apparatus 10 calculates the degree of contribution in the time direction on the basis of the time-series data 20 (see FIG. 1(4)). In the example of FIG. 1, it can be seen from the calculated degree of contribution that the time that has influenced the abnormality score at time t is the latter half of the section from time t-w to time t−1.

Therefore, the processing of the abnormality detection apparatus 10 makes it possible to ascertain not only the feature quantity serving as the cause of the abnormality, but also the temporal relevance (see FIG. 1(5)). Based on the above, in the present system, degrees of contributions in a feature quantity direction and a time direction are calculated for a certain time (w hours in FIG. 1) from a time when the abnormality is to be identified for the same model used for abnormality detection, facilitating the cause identification in the time-series abnormality detection. That is, the present system can execute cause identification in consideration of the time-series characteristics in addition to the time-series abnormality detection.

### [Abnormality Detection Processing of Related Art]

Here, a technology related to abnormality detection processing of the related art that is generally performed will be described as a reference technology.

Existing techniques for time-series abnormality detection using machine learning include a scheme using Recurrent Neural Networks (hereinafter referred to as “RNN”) or Long Short Time Memory (hereinafter referred to as “LSTM”). RNN is a neural network with an autoregressive structure and enables prediction by incorporating a hidden layer holding past time information of time-series data. However, the RNN has a disadvantage that it is difficult to model long-term dependency relationship. LSTM is a scheme that improves on this shortcoming, making it possible to learn a long-term dependency relationship by introducing a forgetting gate into the model.

Further, examples of existing technology for identifying a feature quantity serving as an abnormality occurrence cause include an abnormality cause identification technology using a reconstruction error, and a technology for calculating a degree of contribution from a trained model using LIME (Reference 1: Ross, A. S., Hughes, M. C. & DoshiVelez, F. Right for the Right Reasons: Training Differentiable Models by Constraining their Explanations. arXiv [cs.LG] (2017)), SHAP (Reference 2: Lundberg, S. & Lee, S.-I. A Unified Approach to Interpreting Model Predictions. NIPS2017 (2017)), Smooth Grad (Reference 3: Smilkov, D., Thorat, N., Kim, B., Viegas, F. & Wattenberg, M. SmoothGrad: removing noise by adding noise. arXiv [cs.LG] (2017)), or the like.

First, the abnormality cause identification technology using a reconstruction error will be described. The reconstruction error is a value calculated for each feature quantity using a difference between an input layer and an output layer of a model having the input layer, an intermediate layer, and the output layer. The reconstruction error can be calculated by any scheme such as an autoencoder or principal component analysis, which obtains a compression representation of data in the intermediate layer. In the case of a sample that behaves similarly to a trained normal sample, a reconstruction error of each feature quantity is reduced by correct restoration in the output layer, and in the case of a sample that behaves differently from normal data, the restoration in the output layer fails and the reconstruction error increases. Therefore, visualization, statistic calculation, or the like is performed on the reconstruction error, and a feature quantity having a great value is estimated as an abnormality cause.

Next, a technology for calculating the degree of contribution using a trained model will be described. In the above LIME or SHAP, the degree of contribution of each feature quantity is output by selecting a sample whose cause is to be estimated and creating a new model for estimating the cause. On the other hand, there is also a technology for outputting the degree of contribution by calculating a gradient of an input sample with respect to an output result, and a typical example may include the Smooth Grad. Here, Smooth Grad can create a plurality of samples by intentionally adding Gaussian noise to the input samples, and average results, thereby outputting the degree of contribution with less noise. These schemes are mainly applied to classification models using supervised learning, but can also be applied to an unsupervised abnormality detection scheme by attaching normal/abnormality labels on the basis of an abnormality score and a threshold value.

However, since both an abnormality cause identification technology using the reconstruction error described above and a technology for outputting a degree of contribution from a trained model handle each sample independently in a time direction, a degree of contribution not taking context of data in the time direction into consideration is output. Therefore, it is insufficient as a cause estimation technology for time-series abnormality detection.

On the other hand, an example of a technology for outputting the degree of contribution in consideration of context of data in the time direction includes MTEX-CNN (see NPL 1, for example). MTEX-CNN uses supervised learning to create a series classification model, and uses Grad-CAM, which can present a determination basis using a value output by the last convolutional layer of the CNN to output the degree of contribution. MTEX-CNN can perform time-series classification and degree-of-contribution output in the same model, and can output a degree of contribution in the feature quantity direction indicating which feature quantity of the input data separated by a time window has contributed to a classification result and a degree of contribution in the time direction indicating which time of the input data has contributed to the classification result.

However, since the MTEX-CNN described above is a scheme for supervised learning and classification problems, it is necessary to devise application to the unsupervised abnormality detection.

Hereinafter, since problems that cannot be solved by the related art will be described. Since the existing technology for identifying the cause for abnormality detection treats each sample independently in the time direction, the degree of contribution is output without considering the context of the selected sample. However, it is known that a behavior of time-series data changes depending on a previous time (Reference 4: Brockwell, P. J., Davis, R. A. & Fienberg, S. E. Time Series: Theory and Methods: Theory and Methods. (Springer Science & Business Media, 1991)).

In the case of an abnormality that gradually progresses and becomes larger, such as deterioration over time, the abnormality score rises moderately, and thus, it can be said that this is an abnormality trend unique to time-series data. As estimation of the cause of such an abnormality that tends to have a time delay from the occurrence of an abnormality to an increase in the abnormality score, it can be said that it is preferable to present whether an increase in the abnormality score is influenced from which time, in addition to whether a certain feature quantity is a cause of the increase in the abnormality score at a point in prediction time. This means outputting the degree of contribution to the time in addition to the degree of contribution of the feature quantity, which cannot be dealt with by a technology for identifying the cause of abnormality in existing technology. Therefore, there is a need for a technology capable of outputting the degree of contribution to unsupervised time-series abnormality detection in consideration of the relationship in the time direction before the abnormality occurrence time.

### [Configuration of Abnormality Detection Apparatus 10]

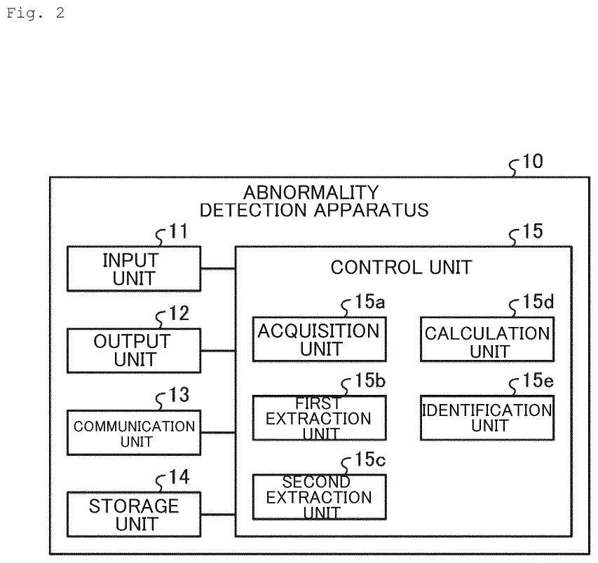

Next, a configuration of the abnormality detection apparatus 10 according to the present embodiment will be described in detail with reference to FIG. 2. FIG. 2 is a block diagram illustrating a configuration example of an abnormality detection apparatus according to the first embodiment. The abnormality detection apparatus 10 includes an input unit 11, an output unit 12, a communication unit 13, a storage unit 14, and a control unit 15.

### (1. Input Unit 11)

The input unit 11 serves to input various types of information to the abnormality detection apparatus 10. For example, the input unit 11 is realized by a mouse, a keyboard, or the like, and receives an input of setting information or the like to the abnormality detection apparatus 10.

### (2. Output Unit 12)

The output unit 12 controls output of various types of information from the abnormality detection apparatus 10. For example, the output unit 12 is realized by a display or the like, and outputs setting information or the like stored in the abnormality detection apparatus 10.

### (3. Communication Unit 13)

The communication unit 13 performs data communication with another device. For example, the communication unit 13 performs data communication with each communication apparatus. Further, the communication unit 13 can perform data communication with a terminal of an operator (not illustrated).

### (4. Storage Unit 14)

The storage unit 14 stores various types of information referred to when the control unit 15 operates and various types of information acquired when the control unit 15 operates. Here, the storage unit 14 can be realized by, for example, a semiconductor memory device such as a random access memory (RAM) or a flash memory, or a storage device such as a hard disk or an optical disc. In the example of FIG. 2, the storage unit 14 is installed inside the abnormality detection apparatus 10, but the storage unit 14 may be installed outside the abnormality detection apparatus 10, and a plurality of storage units may be installed.

### (5. Control Unit 15)

The control unit 15 controls the entire abnormality detection apparatus 10. The control unit 15 includes an acquisition unit 15a, a first extraction unit 15b, a second extraction unit 15c, a calculation unit 15d, and an identification unit 15e. Here, the control unit 15 is, for example, an electronic circuit such as a central processing unit (CPU) or a micro processing unit (MPU) or an integrated circuit such as an Application Specific Integrated Circuit (ASIC) or Field Programmable Gate Array (FPGA).

### (5-1. Acquisition Unit 15a)

The acquisition unit 15a acquires time-series data of a detection target in which an abnormality is detected at a predetermined point in time. For example, the acquisition unit 15a acquires data including sensor values transmitted from a plurality of sensors at each time. On the other hand, the acquisition unit 15a outputs the acquired time-series data to the first extraction unit 15b. Further, the acquisition unit 15a may store the acquired time-series data in the storage unit 14.

### (5-2. First Extraction Unit 15b)

The first extraction unit 15b extracts features in the feature quantity direction in a time section before a predetermined point in time from the time-series data. For example, the first extraction unit 15b performs two-dimensional convolution on each feature quantity of the time-series data to extract the feature in the feature quantity direction. The first extraction unit 15b also outputs a first feature quantity map (feature quantity map 1) as the feature in the feature quantity direction.

To describe the details of the processing, for example, the first extraction unit 15b performs two-dimensional convolution twice on each feature quantity of the time-window w and d-dimensional time-series data, and compresses a feature quantity map into a (w/4)×d dimension. Further, the first extraction unit 15b sets the number of filters for the first time to 64 and the number of filters for the second time to 128, and performs convolution, thereby performing extraction of the feature in the feature quantity direction. The processing for extracting the feature in the feature quantity direction in the first extraction unit 15b will be described below in [Details of Processing] (2. Feature Extraction Processing).

### (5-3. Second Extraction Unit 15c)

The second extraction unit 15c extracts the feature in the time direction in a predetermined time section from the feature in the feature quantity direction. For example, the second extraction unit 15c performs one-dimensional convolution on each feature quantity of the feature in the feature quantity direction to extract the feature in the time direction. The second extraction unit 15c also outputs a second feature quantity map (feature quantity map 2) as the feature in the time direction.

In details of the processing, for example, the second extraction unit 15c performs one-dimensional convolution on a d-dimensional first feature quantity map to use all d-dimensional feature quantities, thereby performing extraction of the feature in the time direction of the entire input data. The processing for extracting the feature in the time direction in the second extraction unit 15c will be described below in [Details of Processing] (2. Feature Extraction Processing).

### (5-4. Calculation Unit 15d)

The calculation unit 15d calculates an abnormality score at a predetermined point in time on the basis of the feature in the feature quantity direction and the feature in the time direction, and calculates the degree of contribution in the feature quantity direction and the degree of contribution in the time direction to the abnormality score before a predetermined point in time. For example, the calculation unit 15d calculates an abnormality score at a predetermined point in time, and calculates the degree of contribution in the feature quantity direction and the degree of contribution in the time direction, using an unsupervised learning model.

Further, the calculation unit 15d calculates the abnormality score and calculates the degree of contribution in the feature quantity direction and the degree of contribution in the time direction using an unsupervised learning model trained using a loss function composed of a penalty for at least one of the prediction error of the abnormality score, the degree of contribution in the feature quantity direction, and the degree of contribution in the time direction.

In details of the processing, the calculation unit 15d performs backpropagation using the predicted value on a final layer subjected to convolution in the feature quantity direction, to calculate a weight from an obtained gradient value. The calculation unit 15d uses an activation function for a matrix obtained by multiplying the obtained weight by the first feature quantity map to output the degree of contribution in the feature quantity direction. Further, the calculation unit 15d performs backpropagation using the predicted value on the final layer subjected to the convolution in the time direction, to calculate a weight from the obtained gradient value. The calculation unit 15d outputs the degree of contribution in the time direction by using an activation function for the matrix obtained by multiplying the obtained weight by the second feature quantity map. Degree-of-contribution calculation processing of the calculation unit 15d will be described below in [Details of Processing] (3. Degree-of-contribution Calculation Processing).

### (5-5. Identification Unit 15e)

When the identification unit 15e detects an abnormality on the basis of the abnormality score, the identification unit 15e identifies the cause of the abnormality using the degree of contribution in the feature quantity direction or the degree of contribution in the time direction. For example, the identification unit 15e identifies a type of sensor as a feature that has influenced the abnormality score at the abnormality occurrence time using the degree of contribution in the feature quantity direction. Further, the identification unit 15e identifies the time that has influenced the abnormality score of the abnormality occurrence time using the degree of contribution in the time direction. Further, the identification unit 15e may store the identified information in the storage unit 14.

### [Details of Processing]

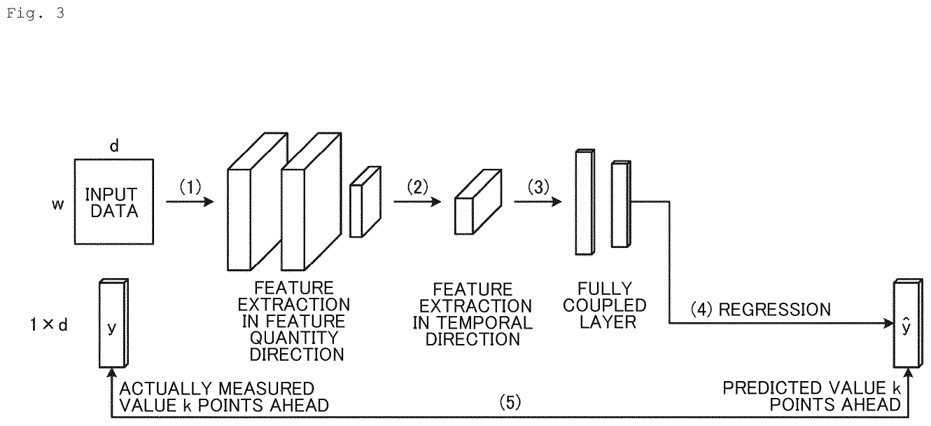

Details of the processing according to the present embodiment will be described with reference to FIGS. 3 to 25 and mathematical equations. Hereinafter, an overview of an architecture of the learning model, feature extraction processing, degree-of-contribution calculation processing, a loss function, and learning model evaluation processing will be described in this order.

### (1. Overview of Architecture of Learning Model)

An overview of an architecture of a learning model (appropriately, the present architecture) according to the present embodiment will be described with reference to FIG. 3. FIG. 3 is a diagram illustrating an example of an architecture of the learning model according to the first embodiment. Hereinafter, the architecture of the learning model that outputs the abnormality score, the degree of contribution in the feature quantity direction, and the degree of contribution in the time direction from the same model will be described.

In this architecture, time-series abnormality detection is performed by creating a model for predicting an actually measured value at a certain point in time using input data with a d-dimensional feature quantity and a w time window using CNN. The certain point in time may be before or after a k time. Further, in the present architecture, two-stage feature extraction using the CNN is performed on the input data. That is, in the present architecture, the extraction of the feature in the feature quantity direction is performed in the first stage (see FIG. 3(1)), and the extraction of the feature in the time direction is performed in the second stage (see FIG. 3(2)). Thereafter, in the present architecture, a fully coupled layer is obtained (see FIG. 3 (3)), an actually measured value y\hat{ } is output (see FIG. 3 (4)), and an error (mean square error, or the like) of the actually measured value y is calculated, so that the abnormality score is calculated (see FIG. 3(5)).

### (2. Feature Extraction Processing)

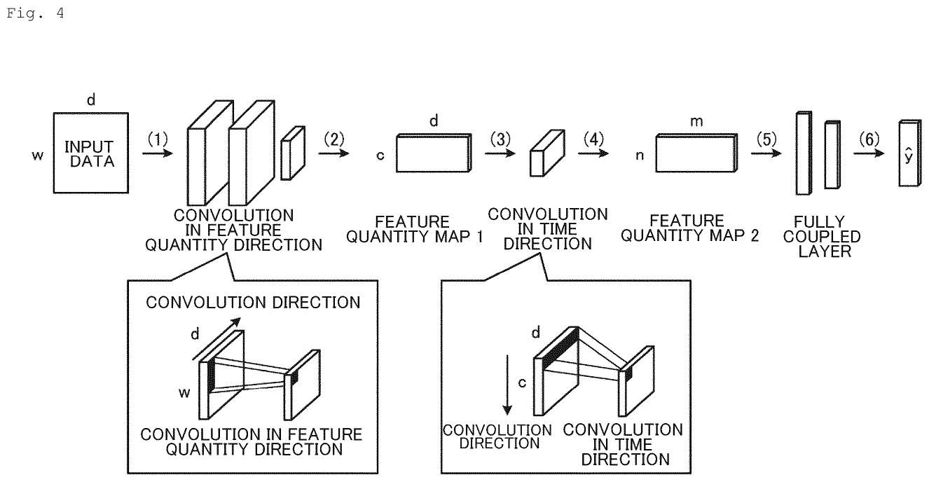

Details of the feature extraction processing will be described with reference to FIG. 4. FIG. 4 is a diagram illustrating an example of feature extraction processing according to the first embodiment. Hereinafter, the processing for extracting the feature in the feature quantity direction and the processing for extracting the feature in the time direction will be described in this order.

### (2-1. Feature Extraction Processing in Feature Quantity Direction)

In the processing for extracting the feature (first extraction processing) in the feature quantity direction at the first stage, first, the abnormality detection apparatus 10 performs two-dimensional convolution multiple times on each feature quantity (see FIG. 4(1)). Next, the abnormality detection apparatus 10 obtains a feature quantity map 1 having a c×d size by transposing the matrix after performing a last two-dimensional convolution in the extraction of the feature in the feature quantity direction (see FIG. 4(2)).

c must be smaller than the time window w. Also, a filter size w′ used for convolution must be w′×1, and w′ is limited to 1<w′<w. For example, the abnormality detection apparatus 10 performs two-dimensional convolution twice, sets w′=4 and c=w/4, and compresses the feature quantity map to (w/4)×d dimensions. Also, the number of filters used for convolution can be set to any value. For example, the abnormality detection apparatus 10 sets the number of filters for the first time to 64 and the number of filters for the second time to 128, and performs convolution. Further, the abnormality detection apparatus 10 may use half padding for convolution in the feature quantity direction.

### (2-2. Processing for Extracting Feature in Time Direction)

In the processing for extracting the feature in the time direction in a second stage (second extraction processing), the abnormality detection apparatus 10 performs one-dimensional convolution on the feature quantity map 1 obtained in the first stage to use all d-dimensional feature quantities, to perform the feature extraction in the time direction of the entire input data (see FIG. 4(3)) to obtain a feature quantity map 2 (see FIG. 4(4)).

The filter size used in this convolution is required to be c′ ×d, with a limit of 1<c′<c. Also, the parameter n is a value determined depending on the filter c′, and is n=c−c′+1. For example, the abnormality detection apparatus 10 sets c′=4 and performs convolution. Further, the abnormality detection apparatus 10 may use half padding for convolution in the time direction.

The abnormality detection apparatus 10 performs the first extraction processing and the second extraction processing described above, obtains a fully coupled layer (see FIG. 4(5)), and outputs the predicted value y\hat{ } (see FIG. 4 (6)).

### (3. Degree-of-Contribution Calculation Processing)

Details of the degree-of-contribution calculation processing will be described as processing following the feature extraction processing. Hereinafter, an overview of the degree-of-contribution calculation processing, the degree-of-contribution calculation processing in the feature quantity direction, and the degree-of-contribution calculation processing in the time direction will be described in this order.

### (3-1. Overview of Degree-of-Contribution Calculation Processing)

First, the abnormality detection apparatus 10 outputs a gradient value by back-propagating the value output from the learning model to the convolutional layer selected using the output value of the learning model, and calculates global average pooling of the gradient value to output a weight. The abnormality detection apparatus 10 converts a matrix obtained by multiplying the feature quantity map obtained from the selected convolutional layer by the obtained weight using an activation function (ReLU function, or the like) to calculate the degree of contribution.

That is, an abnormality detection apparatus 10 executes the degree-of-contribution calculation processing of a feature quantity map 1 (see FIG. 4(2)) that is an output of a layer subjected to extraction of the feature in the feature quantity direction, and a feature quantity map 2 (see FIG. 4 (4)) that is an output of a layer subjected to feature extraction in the time direction, by using the predicted value y\hat{ } at k points ahead (k is an arbitrary variable), and outputs the degree of contribution in the feature quantity direction, the degree of contribution in the time direction, and the degree of contribution to the predicted value at the k points ahead.

### (3-2. Degree-of-Contribution Calculation Processing in Feature Quantity Direction)

The abnormality detection apparatus 10 performs backpropagation using the predicted value yon a final layer subjected to convolution in the feature quantity direction, to calculate a weight by dividing the gradient value obtained here by c. The abnormality detection apparatus 10 outputs the degree of contribution by using an activation function for the matrix obtained by multiplying the obtained weight by the feature quantity map 1.

In the abnormality detection apparatus 10, since the degree of contribution to the feature quantity map 1 is a c×d dimension, and the degree of contribution output with the dimension not matching the input data cannot be interpreted, the size is changed into a w×d dimension that is the same as a size of the input data so that the interpretable degree of contribution in the feature quantity direction is output. For example, the abnormality detection apparatus 10 changes a size from (w/4)×d dimensions to w×d dimensions and outputs the degree of contribution in the feature quantity direction.

### (3-3. Degree-of-Contribution Calculation Processing in Time Direction)

The abnormality detection apparatus 10 performs backpropagation using the predicted value yon the final layer subjected to convolution in the time direction, and divides the gradient value obtained here by n to calculate the weight. The abnormality detection apparatus 10 outputs the degree of contribution by using the activation function for the matrix obtained by multiplying the obtained weight by the feature quantity map 2.

In the abnormality detection apparatus 10, since the degree of contribution to the feature quantity map 2 is an n×m dimension, and the time window w of the input data does not match the size, the size is changed into a w×1 dimension so that the degree of contribution in the time direction is output.

### (4. Loss Function)

Details of the loss function for learning the learning model according to the present embodiment will be described. First, a loss function Loss is represented by the following Equation (1).

$$\begin{matrix}[ Math . 1 ] & \\ Loss = {L}_{ad} + {L}_{feature} + {L}_{time} & ( 1 )\end{matrix}$$

L_{ad} constituting the loss function Loss is represented by Equation (2) below.

$$\begin{matrix}[ Math . 2 ] & \\ {L}_{ad} = {\sum }_{i = 1}^{d} ‖ {y}_{i} - {\hat{y}}_{l} ‖ & ( 2 )\end{matrix}$$

L_{feature} constituting the loss function Loss are expressed as in Equation (3) below.

$$\begin{matrix}[ Math . 3 ] & \\ {L}_{feature} = \frac{1}{\vert A \vert} {\sum }_{j = 1}^{d} {\sum }_{k = 1}^{w} ( 1 - {A}_{j , k} ) & ( 3 )\end{matrix}$$

Lₜᵢₘₑ constituting the loss function Loss is expressed as in Equation (4) below.

$$\begin{matrix}[ Math . 4 ] & \\ {L}_{time} = \frac{1}{\vert B \vert} {\sum }_{j = 1}^{d} {\sum }_{k = 1}^{w} ( 1 - {B}_{j , k} ) & ( 4 )\end{matrix}$$

Here, ∥yᵢ−y\hat{ }ᵢ∥ in Equation (2) above represents a distance between two vectors, and is specifically calculated using Euclidean distance, mean square error, or the like. Further, A in Equation (3) above represents a matrix of feature quantity contribution, and B in Equation (4) above represents a matrix of time contribution. Further, the loss function Loss in Equation (1) above includes L_{ad} indicating the penalty for the prediction error, L_{feature} indicating the penalty for the degree of contribution of the feature quantity, and Lₜᵢₘₑ indicating the penalty for the degree of contribution of time.

In the loss function Loss of Equation (1) above, a penalty for the degree of contribution (L_{feature}, Lₜᵢₘₑ) adds regularization so that the degree of contribution approaches 0 at the time of learning, and an effect that the degree of contribution becomes low and the degree of contribution to abnormal samples becomes high is expected.

Equation (1) of the loss function Loss does not necessarily include the penalty for the degree of contribution, and may include only the penalty L_{ad} for the prediction error or the penalty for one of the degrees of contribution (L_{feature}, Lₜᵢₘₑ). Further, Equations (3) and (4) of the penalty for the degree of contribution are not limited thereto as long as the equations are regularizations yielding the same effects. Hereinafter, a scheme using a loss function of only the prediction error is referred to as a “scheme with no regularization”, and a scheme for regularization so that a high degree of contribution to data not present at the time of learning is output, in addition to the prediction error is referred to as a “scheme with regularization”.

### (5. Learning Model Evaluation Processing)

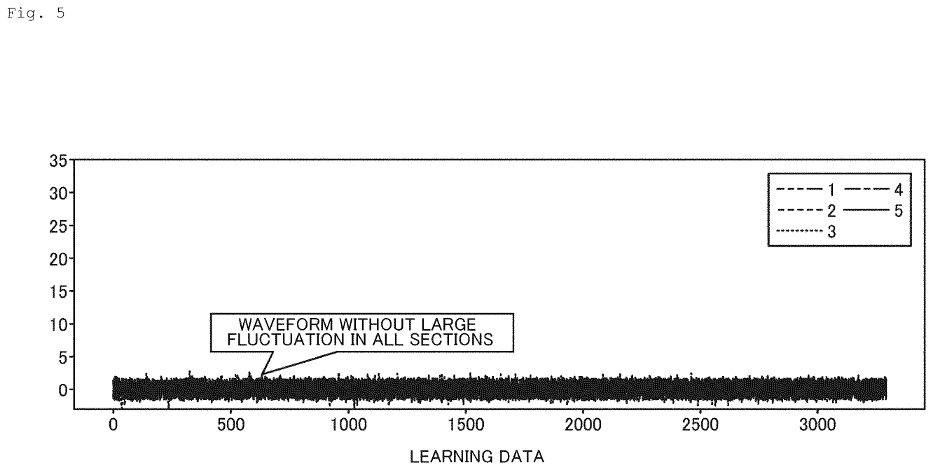

Details of the learning model evaluation processing according to the present embodiment will be described with reference to FIGS. 5 to 25. Hereinafter, an overview of the learning model evaluation processing, evaluation processing using the scheme with no regularization, evaluation processing using the scheme with regularization, and effectiveness of the learning model will be described in this order. The learning model evaluation processing according to the present embodiment is not limited to the processing described below.

### (5-1. Overview of Learning Model Evaluation Processing)

An overview of the learning model evaluation processing according to the present embodiment will be described with reference to FIGS. 5 to 16. Hereinafter, creation of data used in the learning model, data processing, evaluation of abnormality detection accuracy, and evaluation of the degree of contribution will be described in this order.

### (5-1-1. Creation of Data)

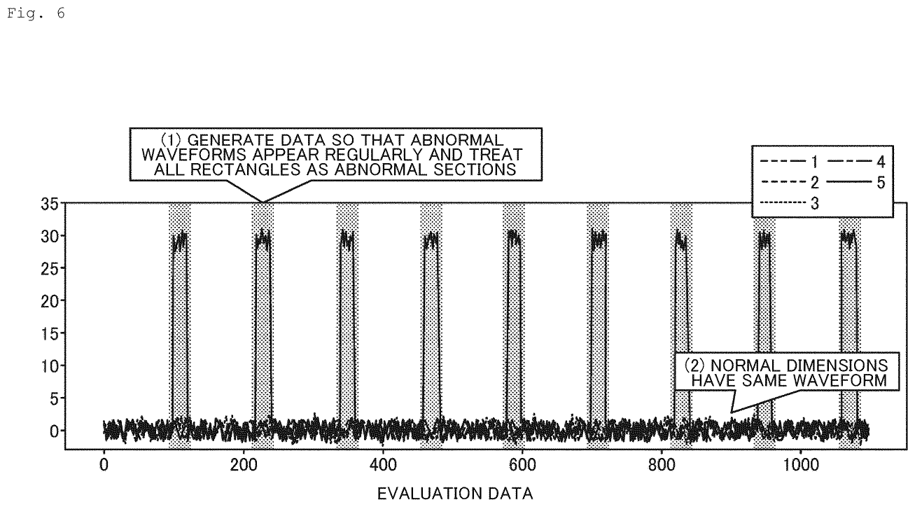

Creation of data used for the learning model will be described with reference to FIGS. 5 and 6. FIG. 5 is a diagram illustrating an example of learning data according to the first embodiment. FIG. 6 is a diagram illustrating an example of evaluation data according to the first embodiment.

As the data used for the learning model, artificial data with 5-dimensional features quantity is created. Here, a difference between learning data and evaluation data is as follows.

For the one- to four-dimensions (normal dimensions), both learning data and evaluation data are generated according to the same rule, and there is no difference. That is, as illustrated in FIG. 5, in the learning data, a waveform without large fluctuations in all sections is shown. Also, as illustrated in FIG. 6(2), in the case of the evaluation data, the same waveform as the learning data is shown in the normal dimension.

For a fifth dimension (abnormal dimension), learning data is generated by combining a trigonometric function with a uniform distribution. On the other hand, the evaluation data is generated according to the same rule as the learning data, and significantly great values are periodically added to create a pseudo abnormal state. That is, as illustrated in FIG. 6(1), data is generated so that an abnormal waveform appears periodically. Further, in FIG. 6(1), all rectangular portions indicated by hatching are treated as abnormal sections.

### (5-1-2. Data Processing)

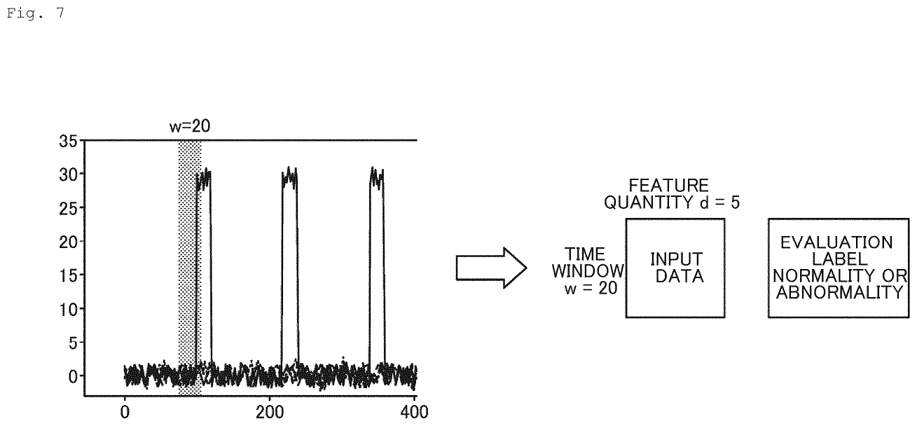

Processing of data used for the learning model will be described with reference to FIGS. 7 to 9. FIGS. 7 to 9 are diagrams illustrating an example of data processing according to the first embodiment.

First, as illustrated in FIG. 7, the time-series data is extracted by a time window, converted into a data format that can be input to the model, and labeled. Although the time window w=20 in FIG. 7, the present invention is not particularly limited.

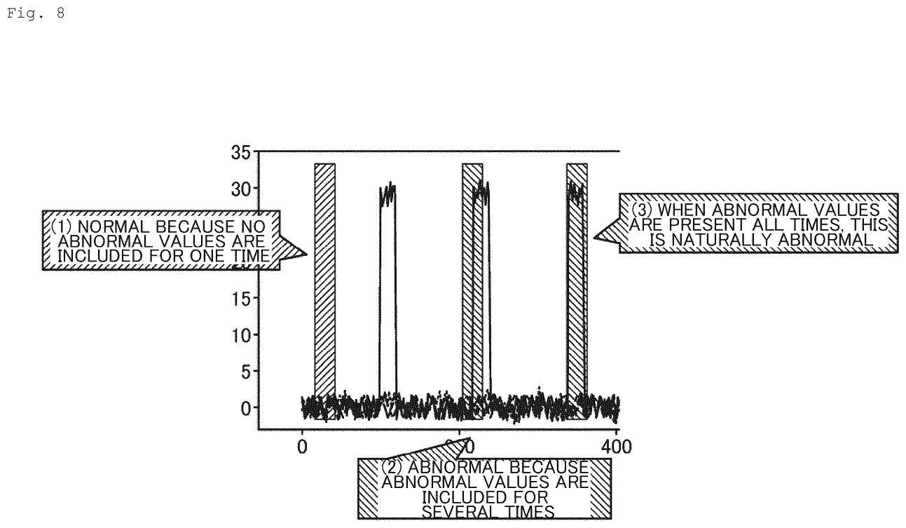

Next, when an abnormal value is included in the five-dimension of the data extracted by the time window even for one time, an abnormality label is assigned. Here, as illustrated in FIG. 8(1), when no abnormal value is included even for one time, a normality label is assigned. As illustrated in FIG. 8(2), when an abnormal value is included for several times, an abnormality label is assigned. As illustrated in FIG. 8(3), when abnormal values are present for all times, this is naturally abnormal, the abnormality label is assigned.

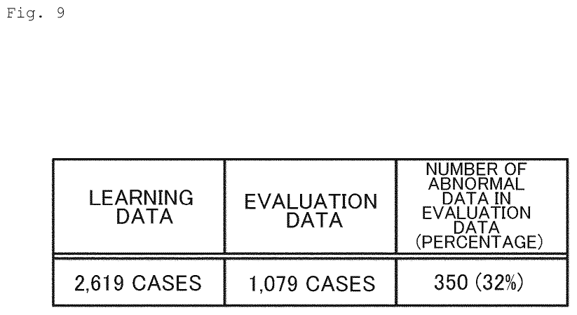

Further, in FIG. 9, it can be seen that among 1079 evaluation pieces of data, 350 abnormal pieces of data are included, and about 32, of abnormal data are included in the created artificial data.

### (5-1-3. Evaluation of Abnormality Detection Accuracy)

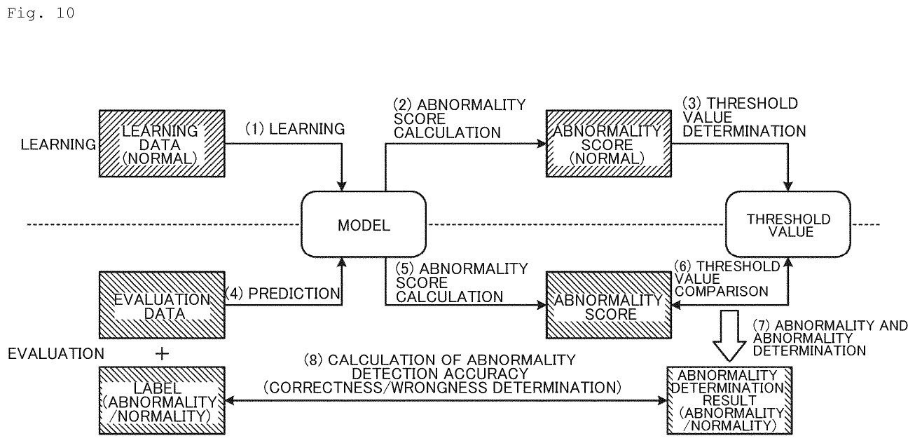

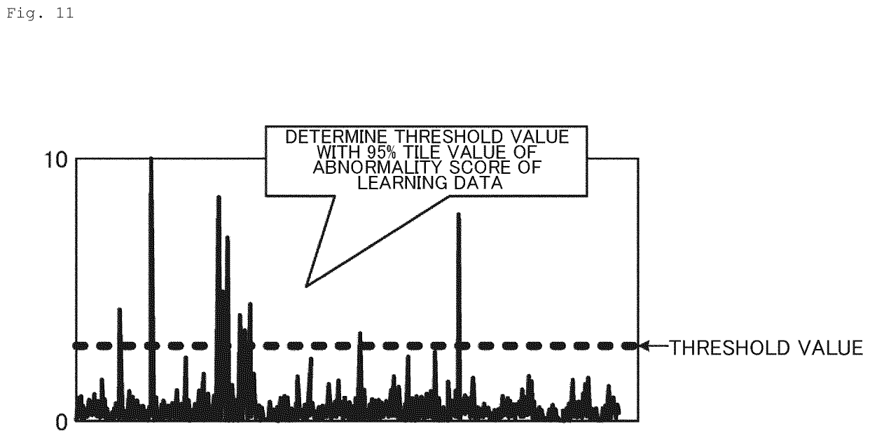

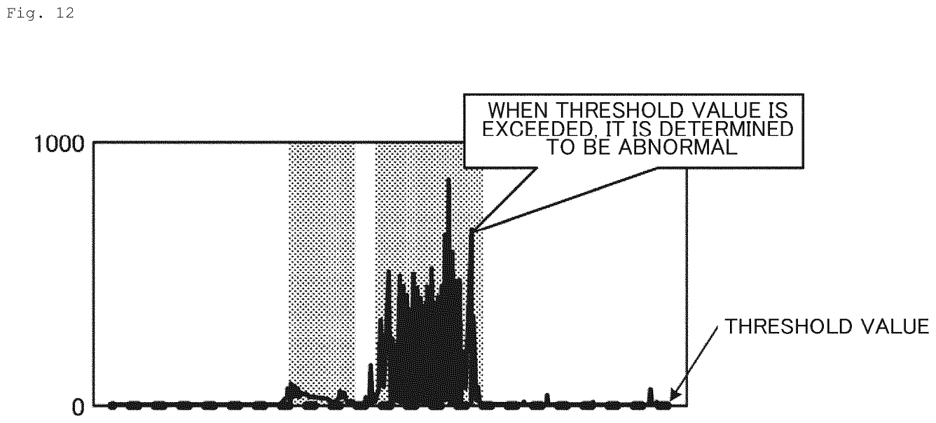

Evaluation of abnormality detection accuracy will be described with reference to FIGS. 10 to 12. FIG. 10 is a diagram illustrating an example of a flow of abnormality detection accuracy evaluation processing according to the first embodiment. FIGS. 11 and 12 are diagrams illustrating an example of abnormality detection accuracy evaluation processing according to the first embodiment.

A flow of evaluation performed by calculating the abnormality detection accuracy by comparing the abnormality label/normality label of the evaluation data with the abnormality determination result will be described with reference to FIG. 10. In the learning processing, first, normal learning data is input and the learning model is learned (see FIG. 10(1)). Next, the learning model calculates an abnormality score and outputs an abnormality score within a normal range (see FIG. 10(2)). A threshold value is determined using the output abnormality score. The determination of the threshold value will be described below with reference to FIG. 11.

On the other hand, in the evaluation processing, first, the evaluation data is input to the learning model and prediction is performed (see FIG. 10(4)). Next, the learning model calculates an abnormality score and outputs the abnormality score (see FIG. 10(5)). The output abnormality score is compared with the determined threshold value (see FIG. 10(6)), the abnormality or normality is determined, and a determination result is output (see FIG. 10(7)). Finally, a correctness/wrongness determination is performed from the label of the evaluation data and the determination result to evaluate the abnormality detection accuracy (see FIG. 10(8)). It is assumed that a relevance rate, a recall rate, F1 score, and Receiver Operating Characteristic-Area Under the Curve (ROC-AUC) are used as evaluation indices, and an average value of 5 trials is calculated in numerical value calculation.

Further, a determination of the threshold value and a determination of abnormality using the threshold value will be described with reference to FIGS. 11 and 12. First, for the threshold value used for an abnormality determination, an abnormality score is calculated for all pieces of learning data, and a 95% tile value thereof is set as the threshold value (see FIG. 11). On the other hand, when the determined threshold value is exceeded, the evaluation data is determined to be abnormal (see FIG. 12).

### (5-1-4. Degree-of-Contribution Evaluation)

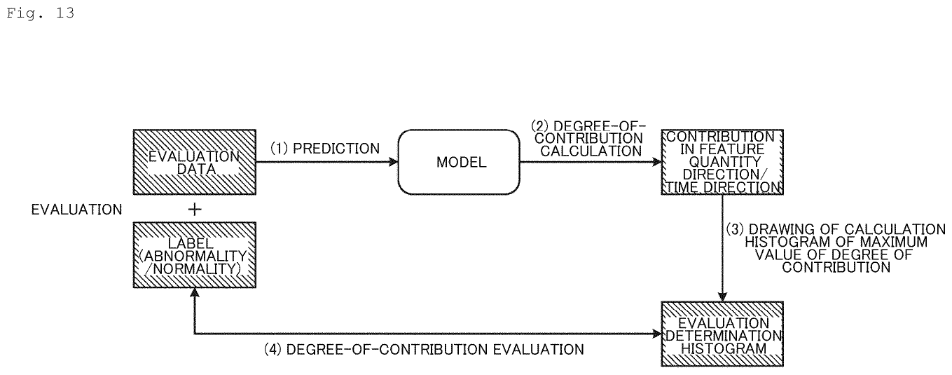

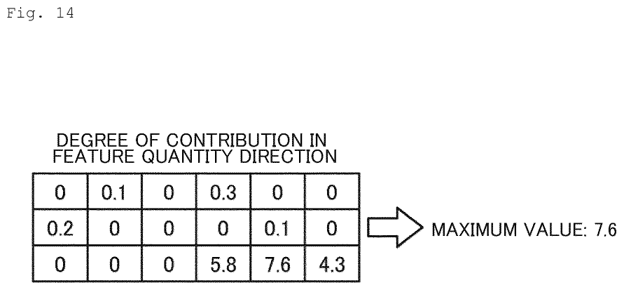

Evaluation of the degree of contribution will be described with reference to FIGS. 13 to 16. FIG. 13 is a diagram illustrating an example of a flow of degree-of-contribution evaluation processing according to the first embodiment. FIGS. 14 to 16 are diagrams illustrating an example of degree-of-contribution evaluation processing according to the first embodiment.

A flow of degree-of-contribution evaluation will be described with reference to FIG. 13. First, the evaluation data is input to the learning model and prediction is performed (see FIG. 13(1)). Next, the learning model calculates the degree of contribution and outputs the degree of contribution in the feature quantity direction and the time direction (see FIG. 13(2)). A maximum value of the output degree of contribution is calculated and a histogram is drawn (see FIG. 13(3)). Finally, the degree of contribution is evaluated from the label of the evaluation data and the drawn histogram (see FIG. 13(4)).

Processing for calculating a maximum value after calculating the degree of contribution in the feature quantity direction will be described with reference to FIG. 14. In FIG. 14, numerical values calculated as the degree of contribution in the feature quantity direction are shown in tabular form. In FIG. 14, a maximum value “7.6” is output when a histogram of the degree of contribution in the feature quantity direction is drawn.

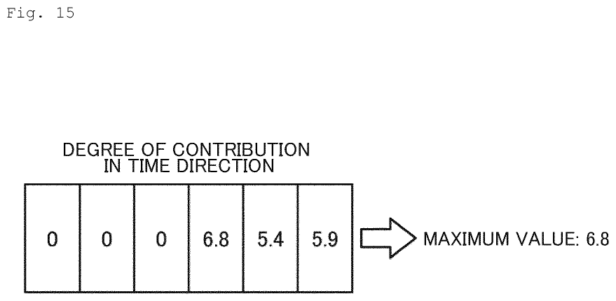

Processing for calculating the maximum value after calculating the degree of contribution in the time direction will be described with reference to FIG. 15. In FIG. 15, numerical values calculated as the degree of contribution in the time direction are shown in tabular form. In FIG. 15, the maximum value “6.8” is output at the time of plotting of the histogram of the degree of contribution in the time direction.

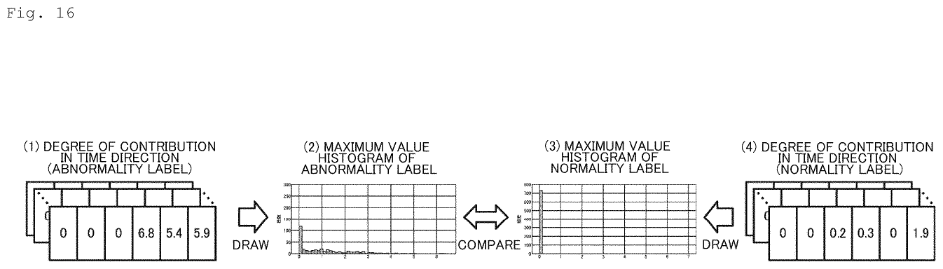

Processing for creating histograms of the maximum values for the normality label and the abnormality label in the feature quantity direction and the time direction and comparing shapes will be described with reference to FIG. 16. Although the degree of contribution in the time direction will be described below, the degree of contribution in the feature quantity direction is similarly processed.

First, the maximum value histogram of the abnormality label is drawn from a plurality of degrees of contribution in the time direction to which abnormality labels are assigned (see FIGS. 16(1) and 16(2)). Here, it is preferable for the maximum value histogram of the abnormality label to be drawn to have a degree of contribution with a heavy-tailed distribution. That is, in the case of an abnormality, a high degree of contribution to the cause of the abnormality should be obtained.

On the other hand, the maximum value histogram of the normality label is drawn from a plurality of degrees of contribution in the time direction to which the normality label is assigned (see FIGS. 16(3) and 16(4)). Here, it is preferable for the maximum value histogram of the normality label to be drawn to have a contribution of 0. That is, in the case of normality, the degree of contribution should be low because this is not the cause of abnormality.

The maximum value histogram of the abnormality label is compared with the maximum value histogram of normality label to evaluate whether the degree of contribution is appropriately reflected (see FIGS. 16(2) and 16(3)).

(5-2. Evaluation Processing Using Scheme with No Regularization)

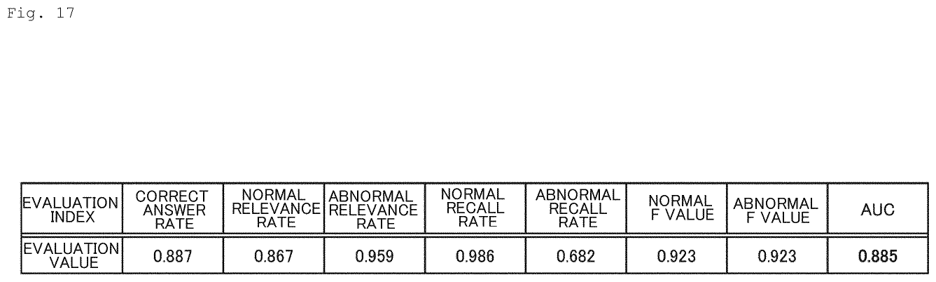

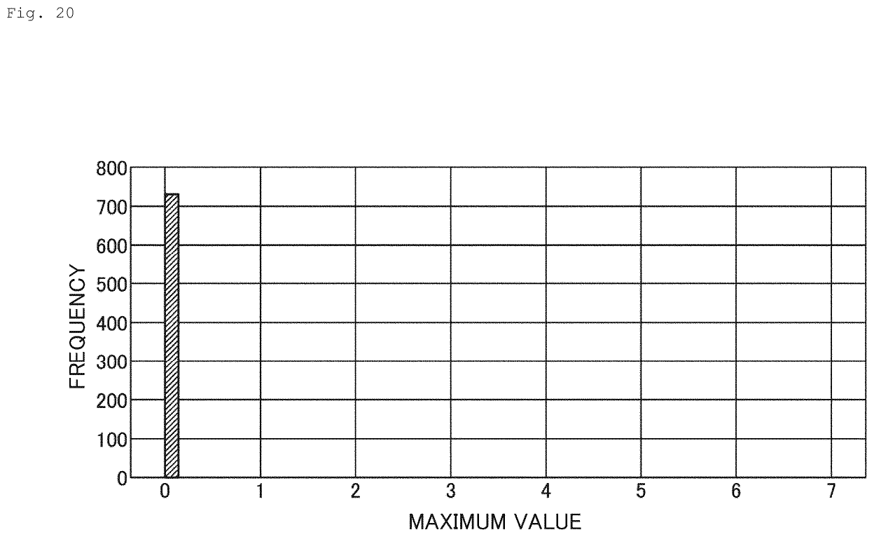

Evaluation processing using a scheme with no regularization of a learning model according to the present embodiment will be described with reference to FIGS. 17 to 20. FIGS. 17 to 19 are diagrams illustrating examples of evaluation results of effectiveness of the architecture of the learning model according to the first embodiment. FIG. 20 is a diagram describing a result of evaluating effectiveness of the architecture of the learning model according to the first embodiment. Hereinafter, the result of evaluating the abnormality detection accuracy and the result of evaluating the degree of contribution will be described in this order.

### (5-2-1. Evaluation Result of Abnormality Detection Accuracy)

First, a result of evaluating the effectiveness of the abnormality detection accuracy of the architecture of the learning model will be described. Hereinafter, an overview of the architecture of the learning model using the scheme with no regularization will be described and then the effectiveness evaluation result will be described.

First, the architecture of the learning model using the scheme with no regularization uses only L_{ad} (see Equation 2) using a mean squared error as the loss function Loss. That is, the abnormality detection processing is performed according to Loss=L_{ad}. Also, the evaluation of the abnormality detection accuracy is performed on the basis of (5-1-3. Evaluation of Abnormality Detection Accuracy) described above. In this case, as a standard of the effectiveness, when AUC is 0.8 or more, a determination is made that the abnormality detection accuracy is effective.

As illustrated in FIG. 17, in the architecture of the learning model using the scheme with no regularization, AUC is 0.885 (average of 5 trials), the abnormality detection accuracy is effective, and a determination is made that it can be fully utilized for abnormality detection.

### (5-2-2. Degree-of-Contribution Evaluation Result)

Next, a result of evaluating the effectiveness of the degree of contribution of the architecture of the learning model will be described. Hereinafter, evaluation of a maximum value histogram of an abnormality label, and evaluation of a maximum value histogram of a normality label will be described in order on the basis of the degree of contribution in the time direction.

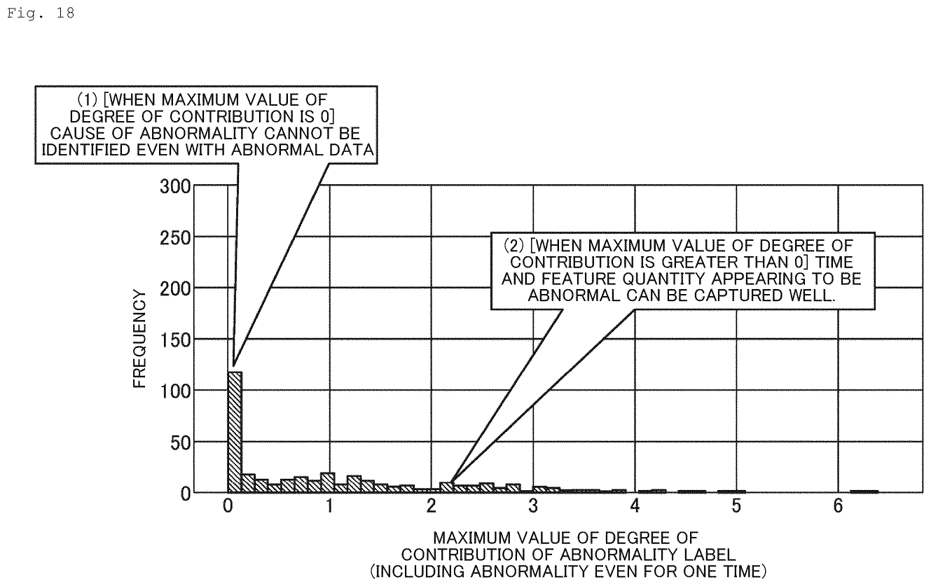

First, the evaluation of the maximum value histogram of the abnormality label will be described with reference to FIG. 18. First, in the maximum value histogram of the abnormality label, when the maximum value of the degree of contribution is 0, it is shown that the cause of the abnormality cannot be identified even with the abnormal data (see FIG. 18(1)). On the other hand, when the maximum value of the degree of contribution is greater than 0, it is shown that the time or the feature quantity considered to be abnormal can be well captured (see FIG. 18(2)). Therefore, in FIG. 18, a determination cannot be made that a high degree of contribution to the abnormality is output, and it cannot be said that the cause of the abnormality is effectively separated.

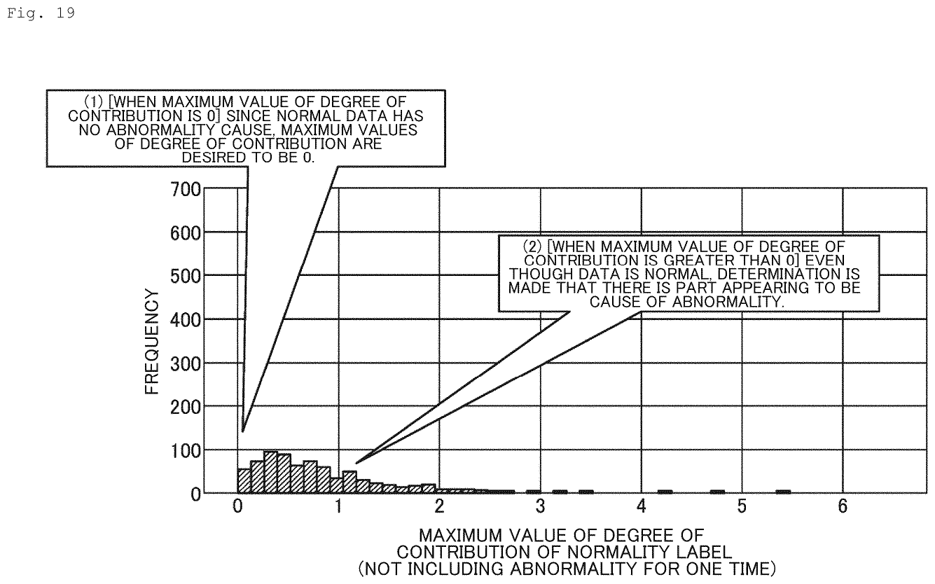

Next, the evaluation of the maximum value histogram of the normality label will be described with reference to FIG. 19. First, in the maximum value histogram of the normality label, when the maximum value of the degree of contribution is 0, the normal data has no abnormality cause, and thus, it is preferable that all the maximum value of the degree of contribution are 0 (see FIG. 19 (1)). That is, as illustrated in FIG. 20, it can be said that a histogram in which all the maximum value of the degree of contribution are 0 is an ideal form. On the other hand, when the maximum value of the degree of contribution is greater than 0, this indicates that a determination is made that there is a portion that is considered to be the cause of abnormality even though the data are normal (see FIG. 19(2)). Therefore, in FIG. 19, a determination cannot be made that a low degree of contribution to normality is output, and it cannot be said that the cause of abnormality is effectively separated.

(5-3. Evaluation Processing Using Scheme with Regularization)

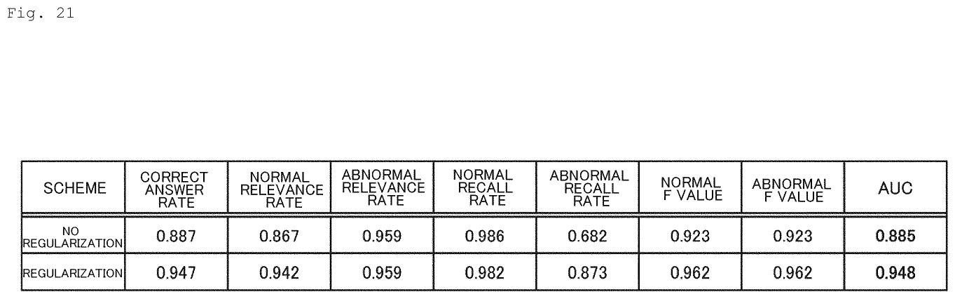

Evaluation processing using the scheme with regularization of the learning model according to the present embodiment will be described with reference to FIGS. 21 to 25. FIGS. 21 to 25 are diagrams illustrating examples of the result of evaluating the effectiveness of the architecture of the learning model according to the first embodiment. Hereinafter, the result of evaluating the abnormality detection accuracy and the result of evaluating the degree of contribution will be described in this order.

### (5-3-1. Result of Evaluating Abnormality Detection Accuracy)

First, the result of evaluating the effectiveness of the abnormality detection accuracy of the architecture of the learning model will be described. Hereinafter, an overview of the architecture of the learning model using the scheme with regularization will be described and then an effectiveness evaluation result will be described.

First, the architecture of the learning model using the scheme with regularization uses L_{feature} (see Equation 3) and Lₜᵢₘₑ (see Equation 4), in addition to L_{ad} (see Equation 2) using a mean squared error as the loss function Loss. That is, the abnormality detection processing is performed according to Loss=L_{ad}+L_{feature}+Lₜᵢₘₑ (see Equation 1). Also, the evaluation of the abnormality detection accuracy is performed on the basis of (5-1-3. Evaluation of Abnormality Detection Accuracy) described above. In this case, since the regularization is an operation that makes optimization difficult, it may be confirmed that the anomaly detection accuracy does not deteriorate.

As illustrated in FIG. 21, in the architecture of the learning model using the scheme with regularization, an AUC is 0.948 (5 trials average), which exceeds the AUC of 0.885 based on the scheme with no regularization, and it is evaluated that there is no adverse effect of regularization.

(5-3-2. Degree-of-contribution Evaluation Result)

Next, a result of evaluating the effectiveness of the degree of contribution of the architecture of the learning model will be described. Hereinafter, the evaluation of the maximum value histogram of the normality label and the evaluation of the maximum value histogram of the abnormality label will be described in order on the basis of the degree of contribution in the time direction.

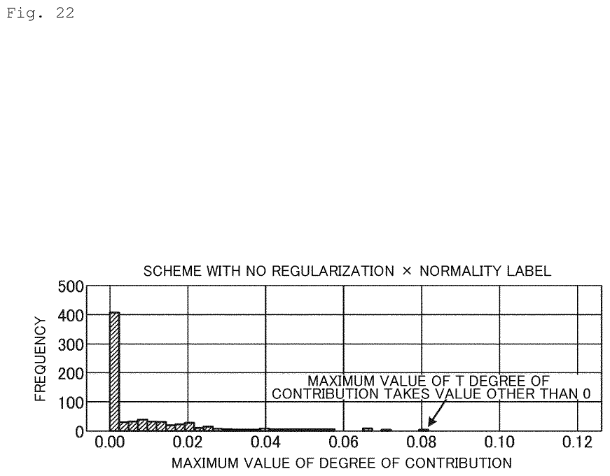

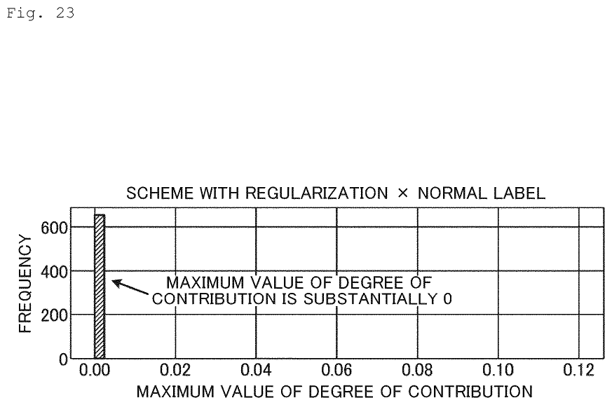

First, the evaluation of the maximum value histogram of the normality label will be described with reference to FIGS. 22 and 23. FIG. 22 illustrates a maximum value histogram of the normality label drawn by the scheme with no regularization, and the maximum value of the degree of contribution having a value other than zero. On the other hand, FIG. 23 illustrates a maximum value histogram of the normality label drawn by the scheme with regularization, and the maximum value of the degree of contribution is substantially zero. Therefore, it can be seen that the regularization increases a percentage of the maximum value of the degree of contribution of 0 in the maximum value histogram of the normality label, avoiding output of an abnormality cause causing confusion.

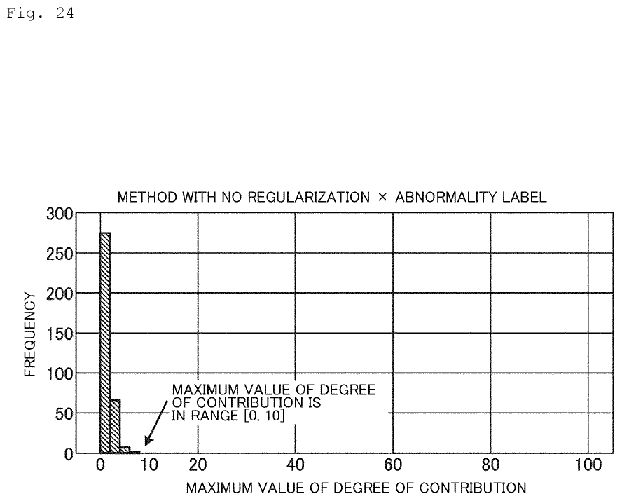

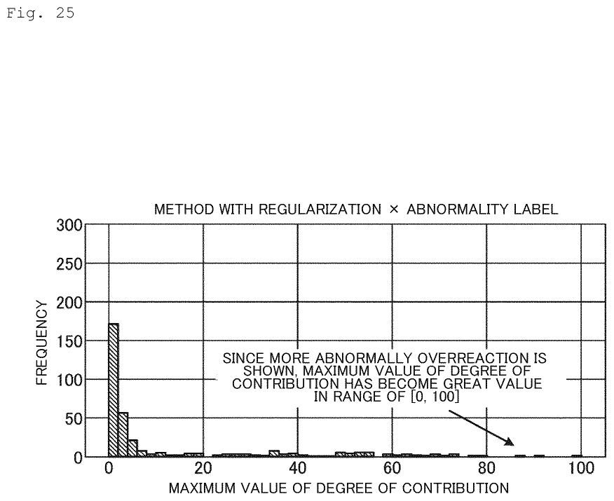

Next, evaluation of the maximum value histogram of the abnormality label will be described with reference to FIGS. 24 and 25. FIG. 24 illustrates a maximum value histogram of the abnormality label drawn by the scheme with no regularization, and the maximum value of the degree of contribution falls within a range of 0 to 10. On the other hand, FIG. 25 illustrates the maximum value histogram of the abnormality label drawn by the scheme with regularization and since more abnormally overreaction is shown, the maximum value of the degree of contribution has become a great value in a range of 0 to 100. Therefore, it can be seen that, in the maximum value histogram of the abnormality label, since the maximum value of the degree of contribution is greater than that in the scheme with no regularization due to regularization, it becomes easy to emphasize the abnormality cause, that is, to identify the abnormality cause.

### (5-4. Effectiveness of Learning Model)

From the above, a determination can be made that the architecture of the learning model according to the present embodiment has performance that can be used for abnormality detection. Further, it becomes easier to identify the cause of abnormality by regularizing the loss function used for learning of the learning model according to the present embodiment.

### [Flow of Processing]

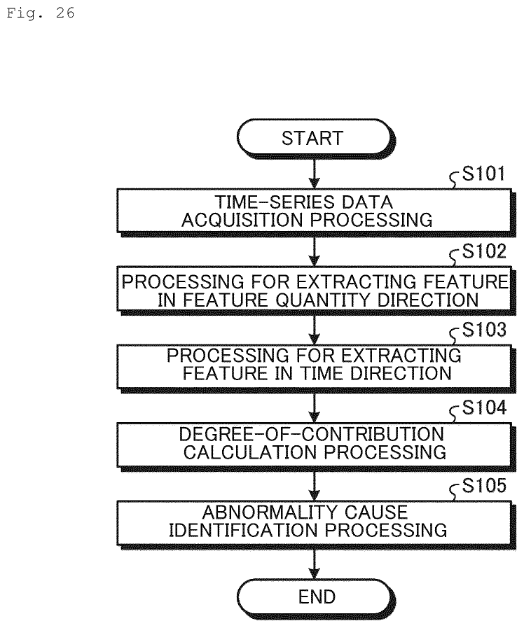

A flow of processing according to the present embodiment will be described in detail with reference to FIG. 26. FIG. 26 is a flowchart illustrating an example of an overall flow of processing according to the first embodiment. Hereinafter, a flow of the whole abnormality detection processing will be shown and an overview of each processing will be described.

### (Flow of Overall Processing)

First, the acquisition unit 15a of the abnormality detection apparatus 10 executes time-series data acquisition processing (step S101). Next, the first extraction unit 15b of the abnormality detection apparatus 10 executes the processing for extracting the feature (first extraction processing) in the feature quantity direction (step S102). Further, the second extraction unit 15c of the abnormality detection apparatus 10 executes the processing for extracting the feature in the time direction (second extraction processing) (step S103). Subsequently, the calculation unit 15d of the abnormality detection apparatus 10 executes the degree-of-contribution calculation processing (step S104). Finally, the identification unit 15e of the abnormality detection apparatus 10 executes abnormality cause identification processing (step S105), and ends the processing. Steps S101 to S105 above can also be executed in a different order. Also, processing of some of steps S101 to S105 above may be omitted.

### (Flow of Each Processing)

First, time-series data acquisition processing in the acquisition unit 15a will be described. In this processing, the acquiring unit 15a acquires time-series data of a detection target whose an abnormality is detected.

Second, the processing for extracting the feature in the feature quantity direction using the first extraction unit 15b will be described. In this processing, first, the first extraction unit 15b performs two-dimensional convolution on each feature quantity multiple times, performs the last two-dimensional convolution in the extraction of the feature in the feature quantity direction, and then transposes a matrix to output the feature quantity map 1.

Third, the processing for extracting the feature quantity in the time direction in the second extraction unit 15c will be described. In this processing, the second extraction unit 15c performs one-dimensional convolution on the feature quantity map 1 output in the processing of step S102 to use all the feature quantities, thereby extracting the feature quantity in the time direction of the entire input data and outputting the feature quantity map 2.

Fourth, the degree-of-contribution calculation processing of the calculation unit 15d will be described. In this processing, the calculation unit 15d outputs a gradient value by back-propagating the value output from the learning model to the convolutional layer selected using the output value of the learning model, and then outputs the weight. The calculation unit 15d calculates the degree of contribution by using an activation function to convert a matrix obtained by multiplying the feature quantity maps output in the processing of steps S102 and S103 by the obtained weight. In this case, the calculation unit 15d outputs the degree of contribution in the feature quantity direction and the degree of contribution in the time direction.

Fifth, the abnormality cause identification processing in the identification unit 15e will be described. In this processing, the identification unit 15e identifies the time and the feature quantity considered to be the cause of the abnormality on the basis of the degree of contribution in the feature quantity direction and the degree of contribution in the time direction output in the processing of step S104.

### [Effects of First Embodiment]

First, in the abnormality detection processing according to the present embodiment described above, time-series data of a detection target whose abnormality is detected at a predetermined point in time is acquired, a feature in a feature quantity direction in a time section before the predetermined point in time is extracted from the time-series data, a feature in a time direction is extracted from the feature in the feature quantity direction, an abnormality score at a predetermined point in time is calculated on the basis of the feature in the feature quantity direction and the feature in the time direction, and the degree of contribution in the feature quantity direction and the degree of contribution in the time direction before the predetermined point in time with respect to the abnormality score are calculated. Therefore, in the present processing, in the unsupervised abnormality detection, cause identification taking the time-series characteristics into consideration is facilitated.

Second, in the abnormality detection processing according to the present embodiment described above, an abnormality score at a predetermined point in time is calculated, and the degree of contribution in the feature quantity direction and the degree of contribution in the time direction are calculated using an unsupervised learning model, and when an abnormality is detected on the basis of the abnormality score, the cause of the abnormality is identified using the degree of contribution in the feature quantity direction or the degree of contribution in the time direction. Therefore, in the present processing, in the unsupervised abnormality detection, the cause identification taking the time-series characteristics into consideration is facilitated, and an influence of a feature or time serving as a cause can be identified.

Third, in the abnormality detection processing according to the present embodiment described above, two-dimensional convolution is performed on each feature quantity of the time-series data, the feature in the feature quantity direction is extracted, and one-dimensional convolution is performed on each feature quantity of the feature in the feature quantity direction to extract the feature in the time direction. Therefore, in the present processing, in the unsupervised abnormality detection, it is possible to easily and efficiently identify the cause in consideration of the time-series characteristics.

Fourth, in the abnormality detection processing according to the present embodiment described above, the abnormality score is calculated and the degree of contribution in the feature quantity direction and the degree of contribution in the time direction are calculated using the unsupervised learning model trained using a loss function composed of a penalty for at least one of the prediction error regarding the abnormality score, the degree of contribution in the feature quantity direction, and the degree of contribution in the time direction. Therefore, in the present processing, in unsupervised abnormality detection, it is possible to easily and accurately identify the cause in consideration of the time-series characteristics.

### [System Configuration, and the Like]

Each component of each apparatus illustrated in the drawings according to the above embodiment is functionally conceptual, and does not necessarily need to be physically configured as illustrated in the drawing. That is, a specific form of distribution and integration of the respective devices is not limited to the illustrated one, and all or a portion thereof can be configured to be functionally or physically distributed and integrated in any units, according to various loads, use situations, and the like. Further, all or some of processing functions performed by each apparatus may be realized by a CPU and a program analyzed and executed by the CPU, or realized as hardware according to wired logic.

Further, all or some of the processes described as being performed automatically among the respective processes described in the embodiment can be performed manually, or all or some of the processes described as being performed manually can be performed automatically using a known method. In addition, information including the processing procedures, control procedures, specific names, and various types of data or parameters illustrated in the above literature or drawings can be arbitrarily changed unless otherwise described.

### [Program]

It is also possible to create a program in which the processing executed by the abnormality detection apparatus 10 described in the above embodiment is described in a computer-executable language. In this case, it is possible to obtain the same effects as those of the above embodiments by the computer executing the program. Further, such a program may be recorded in a computer-readable recording medium, and the program recorded in this recording medium may be read by the computer and executed to realize the same processing as that of the above embodiment.

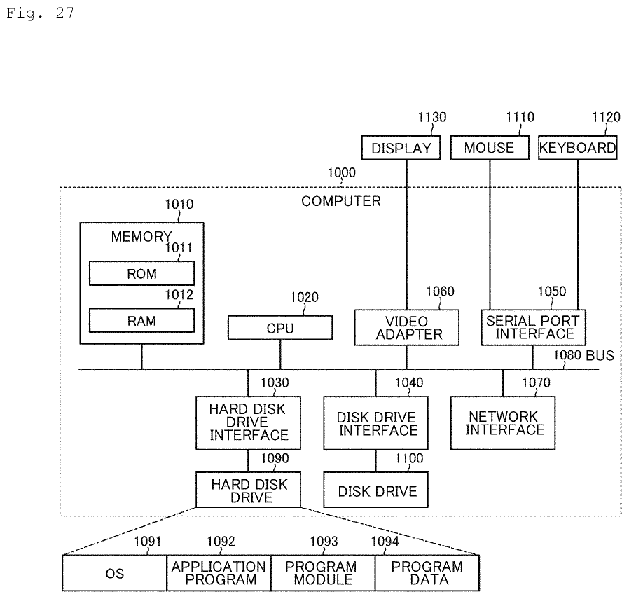

FIG. 27 is a diagram of a computer that executes a program. As illustrated in FIG. 27, a computer 1000 includes a memory 1010, a CPU 1020, a hard disk drive interface 1030, a disk drive interface 1040, a serial port interface 1050, a video adapter 1060, and a network interface 1070, for example, and these units are connected by a bus 1080.

The memory 1010 includes a read only memory (ROM) 1011 and a RAM 1012 as illustrated in FIG. 27. The ROM 1011 stores a boot program such as a Basic Input Output System (BIOS), for example. The hard disk drive interface 1030 is connected to a hard disk drive 1090 as illustrated in FIG. 27. The disk drive interface 1040 is connected to a disk drive 1100 as illustrated in FIG. 27. For example, a removable storage medium such as a magnetic disk or optical disc is inserted into the disk drive 1100. The serial port interface 1050 is connected to, for example, a mouse 1110 and a keyboard 1120, as illustrated in FIG. 27. The video adapter 1060 is connected to a display 1130, for example, as illustrated in FIG. 27.

Here, as illustrated in FIG. 27, the hard disk drive 1090 stores an OS 1091, an application program 1092, a program module 1093, and program data 1094, for example. That is, the above program is stored in the hard disk drive 1090, for example, as a program module in which instructions to be executed by the computer 1000 are described.

Also, various pieces of data described in the above embodiments are stored as program data in the memory 1010 or the hard disk drive 1090, for example. The CPU 1020 reads the program module 1093 or the program data 1094 stored in the memory 1010 or the hard disk drive 1090 into the RAM 1012 as necessary, and executes various processing procedures.

The program module 1093 or the program data 1094 related to the program is not limited to a case in which the program module 1093 or the program data 1094 is stored in the hard disk drive 1090, and for example, the program module 1093 or the program data 1094 may be stored in a removable storage medium and read by the CPU 1020 via a disk drive or the like. Alternatively, the program module 1093 or program data 1094 related to the program may be stored in another computer connected via a network (a local area network (LAN), wide area network (WAN), or the like), and read by the CPU 1020 via the network interface 1070.

The above-described embodiments and modifications thereof are included in the scope of the invention described in the claims and equivalents thereof, as well as in the technology disclosed by the present application.

### REFERENCE SIGNS LIST

10 Abnormality detection apparatus
11 Input unit
12 Output unit
13 Communication unit
14 Storage unit
15 Control unit
15a Acquisition unit
15b First extraction unit
15c Second extraction unit
15d Calculation unit
15e Identification unit
20 Time series data

1. An abnormality detection apparatus comprising:
acquisition circuitry configured to acquire time-series data of a detection target whose abnormality is detected at a predetermined point in time;
first extraction circuitry configured to extract a feature in a feature quantity direction in a time section before the predetermined point in time from the time-series data;
second extraction circuity configured to extract a feature in a time direction in the time section from the feature in the feature quantity direction; and
calculation circuitry configured to calculate an abnormality score at a predetermined point in time on the basis of the feature in the feature quantity direction and the feature in the time direction, and calculate the degree of contribution in the feature quantity direction and the degree of contribution in the time direction before the predetermined point in time with respect to the abnormality score.

2. The abnormality detection apparatus according to claim 1, wherein:
the calculation circuitry calculates an abnormality score at a predetermined point in time using an unsupervised learning model, and calculates the degree of contribution in the feature quantity direction and the degree of contribution in the time direction, and
the abnormality detection apparatus further comprises identification circuity configured to identify a cause of the abnormality using the degree of contribution in the feature quantity direction or the degree of contribution in the time direction when the abnormality is detected on the basis of the abnormality score.

3. The abnormality detection apparatus according to claim 1, wherein;
the first extraction circuitry performs two-dimensional convolution on each feature quantity of the time-series data to extract the feature in the feature quantity direction, and
the second extraction circuitry performs one-dimensional convolution on each feature quantity of the feature in the feature quantity direction, to extract the feature in the time direction.

4. The abnormality detection apparatus according to claim 1, wherein:
the calculation circuitry calculates the abnormality score and calculates the degree of contribution in the feature quantity direction and the degree of contribution in the time direction using the unsupervised learning model trained using a loss function composed of a penalty for at least one of a prediction error regarding the abnormality score, the degree of contribution in the feature quantity direction, and the degree of contribution in the time direction.

5. An abnormality detection method, comprising:
acquiring time-series data of a detection target whose abnormality is detected at a predetermined point in time;
extracting a feature in a feature quantity direction in a time section before the predetermined point in time from the time-series data;
extracting a feature in a time direction in the time section from the feature in the feature quantity direction; and
calculating an abnormality score at a predetermined point in time on the basis of the feature in the feature quantity direction and the feature in the time direction, and calculating the degree of contribution in the feature quantity direction and the degree of contribution in the time direction before the predetermined point in time with respect to the abnormality score.

6. A non-transitory computer readable medium storing an abnormality detection program for causing a computer to function as the abnormality detection apparatus according to claim 1.

7. A non-transitory computer readable medium storing an abnormality detection program for causing a computer to perform the method of claim 5.
